(19) United States
(12) Patent Application Publication
(10) Pub. No.: US 2007/0230966 A1
(43) Pub. Date: Oct. 4, 2007

(54) Single interface with automatic rate detection and selection for multiple optical communication standards

(76) Inventor: Peter J. Walsh, Colorado Springs, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/397,452

(22) Filed: Apr. 3, 2006

(51) Int. Cl. H04B 10/00

(52) U.S. Cl. 398/155

(57) ABSTRACT

An optical communication interface for insertion into an optical network is capable of automatically recovering an embedded clock from a received optical signal across multiple communication standards. An optical receiver receives an optical signal and converts it into an electrical signal having the embedded clock. A frequency selector controller automatically selects between at least two reference frequencies from different optical communication standards to provide to a clock data recovery block for use in recovering the embedded clock.

### BACKGROUND OF THE INVENTION

Protocol analyzers are used to monitor and analyze the traffic across an optical network, as well as to troubleshoot and debug the components within the optical network. Most protocol analyzers developed and installed today have optical communication interfaces that are designed for a single optical communication standard. However, many different optical communication standards exist for optical networks, and within each standard may be several different data rates and wavelengths of light used.

Therefore, what is needed is an optical communication interface that is capable of operating across multiple optical communication standards, and multiple data rates.

### BRIEF DESCRIPTION OF THE DRAWINGS

FIG. 1 shows a high-level block diagram for an optical communication interface 2 having automatic rate detection.

FIG. 2 shows a block diagram of one of many possible configurations for the frequency selector.

Table 1 is a table of selected optical interface standards, their raw bit rates, and associated clock frequencies:

FIG. 3 shows a flow chart of the controller in the frequency selector.

FIG. 4 shows another embodiment for the frequency selector.

### DETAILED DESCRIPTION

In the present application, the following terms are used with the indicated definition. A frequency Y is a “harmonic” of a frequency X when Y is a integral multiple of X. For example, 250 KiloHertz (KHz) is a harmonic of 50 KHz, because 5*(50 KHz)=250 KHz. A frequency Y is a “binary harmonic” of a frequency X when Y=X*2^{N}, where N is a positive integer. For example, 200 MegaHertz (MHz) is a binary harmonic of 50 MHz, because 200 MHz=(50 MHz)*2².

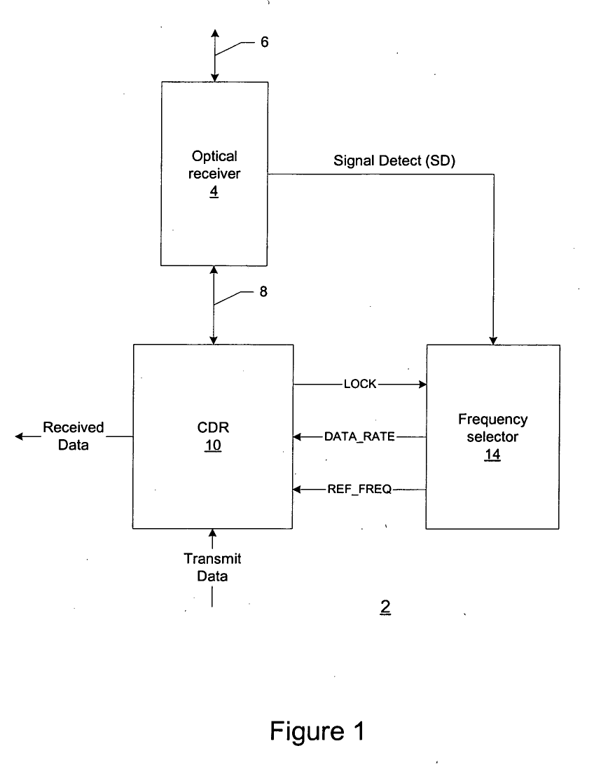

FIG. 1 shows a high-level block diagram for an optical communication interface 2 having automatic rate detection. The optical communication interface 2 can be used in devices such as protocol analyzers, digital communications analyzer (which are used to analyze jitter and eye patterns of an optical signal), and other instruments or devices that may need to be inserted in to an optical network to receive an optical signal. An optical receiver 4 receives an optical signal 6 having an embedded clock and converts it to an electrical signal 8 that is passed on to a clock and data recovery (CDR) block 10. The optical receiver 4 should be capable of detecting optical signals across multiple standards, at multiple data rates at different wavelengths (between 820 nanometers (nm) and 1600 nm), and should generate a SIGNAL DETECT (SD) signal when it receives a valid optical signal. A suitable optical receiver 4 uses an Indium-Gallium-Arsenide (InGaAs) photodiode which detects light pulses within the wavelength range of 820 nm to 1600 nm. One example of a suitable optical receiver is the HFCT-5944 Multi-Rate Optical Transceiver, offered by Avago Technologies (previously Agilent Technologies, Inc.). Other satisfactory optical receivers and transceivers are commercially available.

The CDR block 10 utilizes a phase-locked-loop (PLL) (not shown) to recover the embedded clock (which runs at the same frequency as the raw bit rate) from the electrical signal 8, and generates a LOCK signal once it has successfully recovered the embedded clock. The LOCK signal is an output from the PLL circuit within a CDR indicating that it has phase-locked the raw bit rate of the incoming signal to a harmonic of the applied reference frequency, as modified by its internal divisors. This LOCK signal represents the first level (physical layer) of optical signal standards identification. Beyond this LOCK signal all interfaces in the industry include verification from the media access layer (MAC layer) where special symbols, bit patterns, or a framing pulses specific to each standard, are used to further identify a communication standard before the data can be used. The CDR block 10 should be capable of clock and data recovery across multiple standards. One example of a suitable CDR block 10 is the VSC8142 Multi-Rate Transceiver, offered by Vitesse Semiconductor Corporation. Other satisfactory CDR blocks are commercially available.

The PLL in the CDR block 10 requires a reference frequency (REF_FREQ), operating at the same (or close to the same) frequency as the embedded clock it needs to recover. It should be noted that the reference frequency does not have to be exactly the same as the embedded clock for the PLL to lock to the incoming data signal. Some margin of error is allowed—the exact amount of error tolerated will depend on the actual CDR block 10 used. Generally, a reference frequency that is within +/−100 parts per million of the embedded clock is sufficient. For example, the REF_FREQ for Gigabit Ethernet 2× should be 2.5 Gigahertz, +/−250 Kilohertz (KHz). A frequency selector 14 receives the signal SD from the optical receiver 4, the LOCK signal from the CDR block 10, and provides REF_FREQ to the CDR block 10.

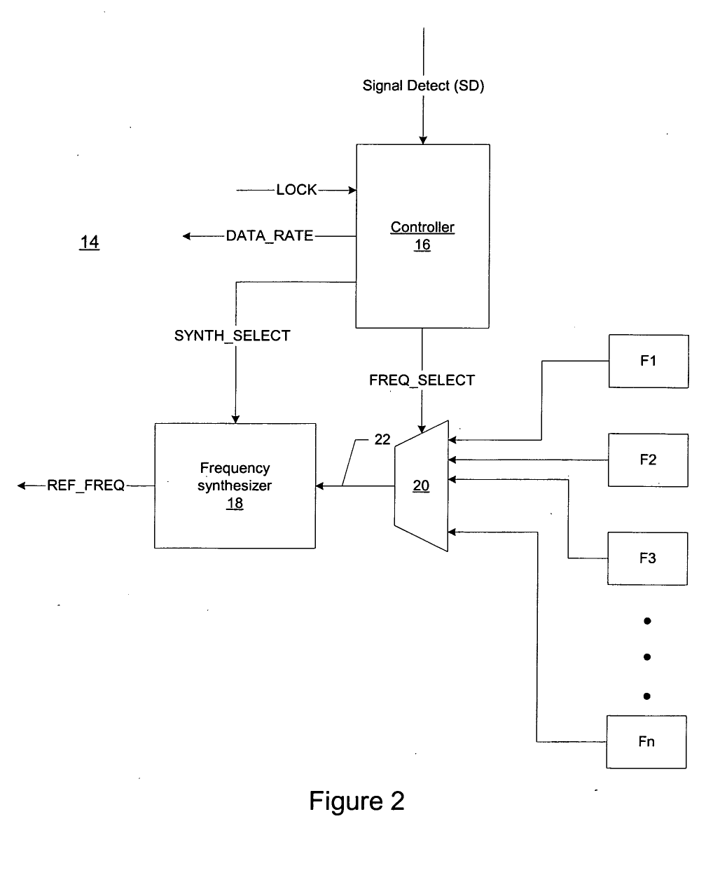

Refer now to FIG. 2, which shows a block diagram of one of many possible configurations for the frequency selector 14. The frequency selector 14 includes a controller 16, a frequency synthesizer 18, a mux 20, and N primary frequency sources F1-Fn.

The controller 16 (described in more detail below) receives the signal SD from the optical receiver 4 and the signal LOCK from the CDR block 10 as input. The controller 16 generates a signal FREQ_SELECT to control a mux 20, which selects one of the N primary frequency sources (F1-Fn) to provide as input 22 to the frequency synthesizer 18. The controller 16 also generates an optional signal DATA_RATE, which is passed to the CDR block 10 and selects the data rate used within a selected communication standard. Finally, the signal SYNTH_SELECT from the controller 16 controls the factor by which the frequency synthesizer 18 multiplies its input 22 to get the REF_FREQ.

The frequency synthesizer 18 takes the selected primary frequency source 22 as input, scales it by a factor controlled by SYNTH_SELECT, and produces a REF_FREQ with low jitter. A suitable frequency synthesizer 18 is the ICS843001-22, offered by Integrated Circuit Systems, Inc. Other satisfactory frequency synthesizers are commercially available.

Further multiplication of the signal REF_FREQ may be performed internally by the CDR block 10 to accommodate multiple data rates within a standard. The internal multiplication factor is controlled by the optional signal DATA_RATE provided by the frequency selector 14. Alternatively, if the primary frequency sources F1-Fn are chosen to generate the desired final signal REF_FREQ without any further mathematical manipulation, the frequency synthesizer 18 and the signal DATA_RATE can be omitted from the frequency selector 14.

There are many different optical communication standards in existence, all operating at different bit rates and requiring different reference frequencies for clock recovery to be performed properly. Table 1 below is a table of selected optical communication standards, the coding schemes used, their raw bit rates, and exemplary primary frequency sources that may be used to generate REF_FREQ.

TABLE 1

| Optical | Coding | | | | Primary |
|---|---|---|---|---|---|
| Communication | Scheme | | | | frequency |
| Standard | Used | Variant | Raw Bit Rate | | source |
| SONET/SDH | NRZ | OC-3/STS- | 155.52 | Mb/s | 19.44 MHz. |
| | | 3/STM-1 | | | (⅛ × bit rate) |
| SONET/SDH | NRZ | OC-12/STS- | 622.08 | Mb/s | 19.44 MHz. |
| | | 12/STM-4 | | | ( 1/32 × bit rate) |
| SONET/SDH | NRZ | OC-48/STS- | 2.48832 | Gb/s | 19.44 MHz. |
| | | 48/STM-16 | | | ( 1/128 × bit rate) |
| SONET/SDH | NRZ | OC-96/STS- | 4.97664 | Gb/s | 19.44 MHz. |
| | | 96/STM-64 | | | ( 1/256 × bit rate) |
| SONET/SDH | NRZ | OC-192/STS- | 9.95328 | Gb/s | 19.44 MHz. |
| | | 192/STM-256 | | | ( 1/512 × bit rate) |
| Gigabit Ethernet | 8B/10B | 1X (base rate) | 1.25 | Gb/s | 19.53125 MHz. |
| (IEEE 802.3z) | | | | | ( 1/64 × bit rate) |
| 1000BASE-LX/SX | | | | | |
| Gigabit Ethernet | 8B/10B | 2X base rate | 2.50 | Gb/s | 19.53125 MHz. |
| (IEEE 802.3z) | | | | | ( 1/128 × bit rate) |
| 1000BASE-LX/SX | | | | | |
| 10 Gigabit Ethernet | 64B/66B | 10X base rate | 10.3125 | Gb/s | 19.53125 MHz. |
| (IEEE 802.3ae) | | | | | ( 1/528 × bit rate) |
| Fibre Channel | 8B/10B | 1X (base rate) | 1.06256 | Gb/s | 16.6025 MHz. |
| ANSI X3T11 | | | | | ( 1/64 × bit rate) |
| Fibre Channel | 8B/10B | 2X base rate | 2.12512 | Gb/s | 16.6025 MHz. |
| ANSI X3T11 | | | | | ( 1/128 × bit rate) |
| Fibre Channel | 8B/10B | 4X base rate | 4.25024 | Gb/s | 16.6025 MHz. |
| ANSI X3T11 | | | | | ( 1/256 × bit rate) |
| Fast Ethernet 100Base-FX | 4B/5B | base rate | 125 | Mb/s | 15.625 MHz. |
| (IEEE 802.3u) | | | | | (⅛ × bit rate) |

Each optical communication standard (e.g. Synchronous Optical Network (SONET), Gigabit Ethernet, Fibre Channel, and Fast Ethernet) is associated with a single primary frequency source that will be used to generate REF_FREQ for that standard. Many of these standards have variants that run at different raw bit rates, with optical signals having different wavelengths (820 nm to 1600 nm), and different types of light sources (e.g. light emitting diodes, lasers). Many communication standards have duplicate specifications regarding light sources and wavelengths, and how they are coupled to different optical fiber types (e.g. single-mode fibers and multi-mode fibers).

Generally, each primary frequency source is a crystal oscillator. The frequency of the crystal oscillator is chosen so that the raw bit rate of its associated communication standard is a harmonic of the crystal oscillator's frequency. Typically the raw bit rate of a communication standard is also a binary harmonic of its associated primary frequency source. (However, there are some exceptions, e.g. 10 Gigabit Ethernet which uses a primary frequency source that is 1/528 of its raw bit rate.) For example, in Table 1, SONET/SDH is associated with a primary frequency source of 19.44 MegaHertz (MHz). There are several different bit rates specified within SONET/SDH, all of which are binary harmonics of the primary frequency source: The variant OC-3 has a raw bit rate of 155.52 Megabits/second (Mb/s), which is 2³ times the primary frequency source (8*19.44 MHz); OC-12 has a raw bit rate of 622.08 Mb/s, which is 2⁵ times the primary frequency source (32*19.44 MHz); and OC-48 has a raw bit rate of 2.48832 Gb/s, which is 2⁷ times the primary frequency source (128*19.44 MHz).

Note that the primary frequency sources shown in Table 1 are exemplary only; there are many other suitable choices for the frequencies of the primary frequency sources F1-Fn, given the various mathematical operations that can be performed on a primary frequency source Fn by the frequency synthesizer 18 to create the desired REF_FREQ, and given the margin of error allowed for the reference frequency. For example, integer multiples of the primary frequency sources listed in Table 1 would also make suitable primary frequency sources.

If the CDR block 10 performs its own internal multiplication to accommodate multiple data rates within a standard, it needs a reference frequency (REF_FREQ) as well as the proper data rate to recover the embedded clock. Without a reference frequency, a PLL becomes much more dependent on the coding scheme used and as such can falsely lock to a date rate that is a binary harmonic of the desired rate, or fail to in distinguish between SONET/SDH OC-48 (2.48832 Gb/s) and Gigabit Ethernet 2× (2.50 Gb/sec). An additional advantage to designing with reference frequencies is the ability to transmit with a specific data rate without having an input signal available to lock to.

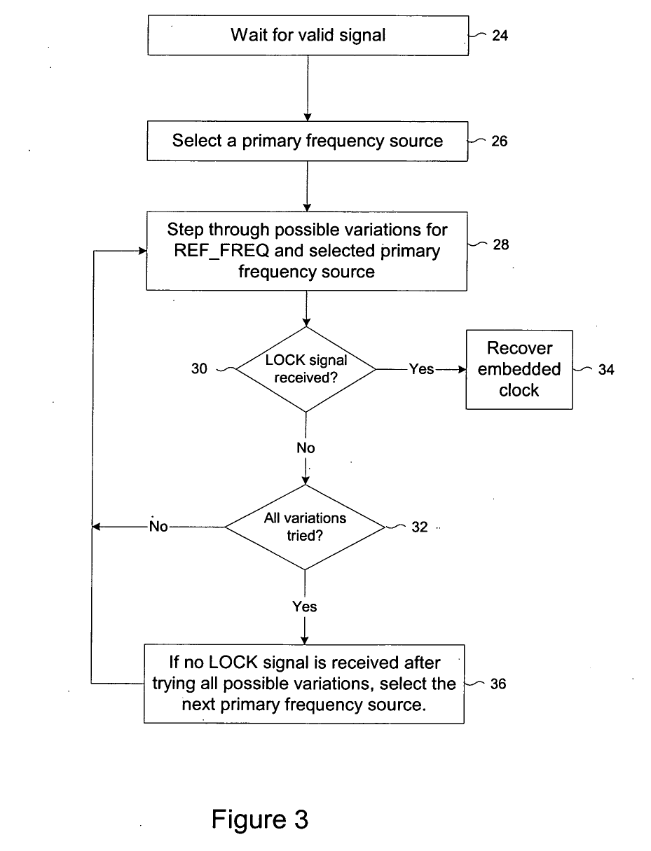

Refer now to FIG. 3, which shows a flow chart for the controller 16. First, the controller 16 waits for the optical receiver 4 to indicate that it has received a valid signal (SD) (step 24). After a valid optical signal (SD) is detected by the optical receiver 4, the controller 16 selects a first primary frequency source from the available primary frequency sources F1 through Fn. The controller signal FREQ_SELECT controls the mux 20 (step 26) and passes a selected primary frequency source 22 to the frequency synthesizer 18.

Next, the controller 16 steps through all variations on the selected primary frequency source 22 and REF_FREQ (step 28). For example, if the CDR block 10 scales REF_FREQ internally to accommodate multiple data rates, the controller 16 should step through the possible data rates (via the DATA_RATE signal) for the communication standard associated with the selected primary frequency source 22. Or, if the scaling of the selected primary frequency source 22 is performed by the frequency synthesizer 18, then the controller 16 should step through the possible frequency synthesizer values (via the SYNTH_SELECT signals). It is possible that the controller 16 will need to vary both DATA_RATE and SYNTH_SELECT. The controller 16 should continue trying the variations until either a LOCK signal is received (step 30), or all of the possible variations have been tried (step 32).

If the LOCK signal is received, then the CDR block 10 successfully recovered the embedded data clock using the selected primary frequency source 22, DATA_RATE, and SYNTH_SELECT (step 34). The amount of time the controller 16 should wait for a LOCK signal is dependent upon the type of CDR block 10 used. Generally, the wait time should be longer than the amount of time it takes for the CDR block 10 to generate a LOCK signal.

If no LOCK signal is detected after a reasonable interval, the controller 16 determines if all of the variations have been tried for the selected primary frequency source (step 32). If there are untried variations remaining for the selected primary frequency source, then the controller 16 returns to step 28 and continues trying the remaining variations as long as SIGNAL DETECT (SD) is asserted. If all of the variations have been tried for the selected primary frequency source, then the controller 16 selects the next primary frequency source (step 36) and returns to step 28 to cycle through the variations for the newly selected primary frequency source.

The controller 16 continues in this manner, selecting one primary frequency source from the available primary frequency sources F1 through Fn, and cycling through the variations for the selected primary frequency source, until a LOCK signal is detected.

After the last primary frequency source Fn has been selected, if still no LOCK signal is asserted by the CDR block 10, then the controller 16 selects F1 and starts the whole process over again. The controller 16 continues to loop as long as SIGNAL DETECT (SD) is asserted, through the primary frequency sources F1 through Fn until a LOCK is found.

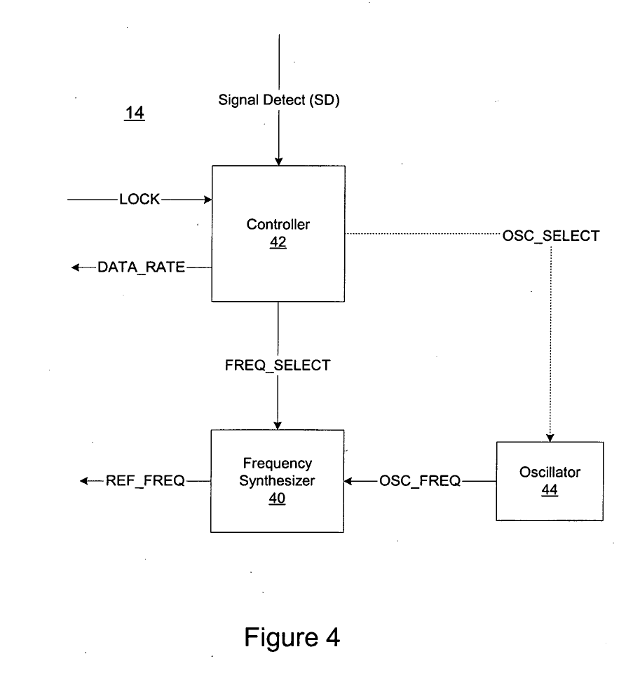

FIG. 4 shows an alternate embodiment for the frequency selector 14. A frequency synthesizer 40 generates the reference frequency REF_FREQ from an oscillator 44. The controller 42 controls the frequency synthesizer 40 with the signal FREQ_SELECT. The oscillator 44 may be a voltage controlled oscillator (VCO) that generates a variable frequency, or a fixed oscillator generating a single frequency. If oscillator 44 is a VCO, then the controller 42 also controls the oscillator 44 with the signal OSC_SELECT to determine its output frequency OSC_FREQ. The output range of the VCO should cover the primary frequency sources listed in Table 1. The frequency synthesizer 40, similar to the frequency synthesizer 18 of FIG. 2, further scales OSC_FREQ as needed to produce the desired REF_FREQ to recover the embedded clock.

If the oscillator 44 is a fixed oscillator, then there is no need for the signal OSC_SELECT from the controller 42, since OSC_FREQ is fixed. Since the numeric width of the multipliers and divisors within frequency synthesizers are increasing, OSC_FREQ serves as a single primary frequency source, and the frequency synthesizer 40 performs various multiply and/or divide operations in conjunction with a PLL to produce the desired reference frequency REF_REQ (within the error margin) to recover the embedded clock.

The operation of controller 42 is similar to that of controller 16. Instead of selecting a primary frequency source, the FREQ_SELECT signal controls the frequency synthesizer 40 (and the OSC_SELECT signal, if oscillator 44 is a VCO) to select a reference frequency REF_FREQ for the CDR 10 to recover the embedded clock. The rest of the operation of the controller 42 remains as described for controller 16 in FIG. 3.

I claim:

1. An optical communication interface for insertion into an optical network, comprising:
an optical receiver that receives an optical signal and converts it into an electrical signal having an embedded clock;
a clock data recovery (CDR) block that uses a reference frequency to recover the embedded clock; and
a frequency selector that automatically selects between at least two values for the reference frequency from different optical communication standards to provide to the CDR block.

2. An optical communication interface as in claim 1, wherein the frequency selector includes:
a controller that cycles through generating the at least two values for the reference frequency until the CDR block indicates it has recovered the embedded clock.

3. An optical communication interface as in claim 2, wherein the at least two values for the reference frequency are generated from at least two primary frequency sources.

4. An optical communication interface as in claim 3, wherein
at least one of the primary frequency sources is associated with an optical communication standard having at least two data rates, and
the controller cycles through the at least two data rates until the CDR block indicates it has recovered the embedded clock.

5. An optical communication interface as in claim 4, wherein the controller selects the data rate for the CDR block.

6. An optical communication interface as in claim 2, wherein
the frequency selector includes a frequency synthesizer that generates the at least two values for the reference frequency from at least two primary frequency sources, and
the controller controls the frequency synthesizer to scale the primary frequency sources by a factor.

7. An optical communication interface as in claim 2, wherein
the CDR block has a margin of error for the reference frequency, and
each of the at least two values for the reference frequency are equal, within the margin of error, to a raw bit rate of an optical communication standard selected from the group consisting of Synchronous Optical Network/Synchronous Digital Hierarchy (SONET/SDH), Gigabit Ethernet, Fibre Channel, and Fast Ethernet.

8. An optical communication interface as in claim 7, wherein the at least two values for the reference frequency are generated from at least two primary frequency sources.

9. An optical communication interface as in claim 8, wherein
each of the at least two primary frequency sources is associated with an optical communication standard selected from the group consisting of Synchronous Optical Network/Synchronous Digital Hierarchy (SONET/SDH), Gigabit Ethernet, Fibre Channel, and Fast Ethernet, and
the raw bit rate of each optical communication standard is a harmonic of its associated primary frequency source

10. An optical communication interface as in claim 9, wherein the raw bit rate of each optical communication standard is a binary harmonic of its associated primary frequency source.

11. An optical communication interface as in claim 7, wherein each of the at least two primary frequency sources is an oscillator having a frequency that is an integral multiple of a frequency selected from the group consisting of 19.44 MHz, 19.53125 MHz, 16.6025 MHz, and 15.625 MHz.

12. An optical communication interface as in claim 2, wherein
the frequency selector includes a frequency synthesizer that generates the at least two values for the reference frequency from a single primary frequency source, and
the controller controls the frequency synthesizer to scale the primary frequency source by a factor.

13. An optical communication interface as in claim 12, wherein the single primary frequency source is a voltage controlled oscillator.

14. A protocol analyzer having an optical communication interface as in claim 1.

15. A method for recovering an embedded clock from an optical signal, comprising:
converting the optical signal to an electrical signal;
using a reference frequency to recover an embedded clock from the electrical signal; and
generating at least two frequencies for use as the reference frequency, each frequency matching a raw data rate from different optical communication standards.

16. A method as in claim 15, wherein each of the at least two frequencies is generated from a different primary frequency source.

17. A method as in claim 16, wherein
each of the primary frequency sources is associated with an optical communication standard selected from the group consisting of Synchronous Optical Network/Synchronous Digital Hierarchy (SONET/SDH), Gigabit Ethernet, Fiber Channel, and Fast Ethernet, and
the raw bit rate of each optical communication standard is a harmonic of its associated primary frequency source

18. A method as in claim 17, wherein the raw bit rate of each optical communication standard is a binary harmonic of its associated frequency source.

19. A method as in claim 18, wherein each of the primary frequency sources is an oscillator having a frequency that is an integral multiple of a frequency selected from the group consisting of 19.44 MHz, 19.53125 MHz, 16.6025 MHz, and 15.625 MHz.
